(19) United States
(12) Patent Application Publication
(10) Pub. No.: US 2025/0383712 A1
(43) Pub. Date: Dec. 18, 2025

(54) EMOTION-BASED EXPERIENCE

(71) Applicants: HX LAB LTD, Cambridgeshire (GB); NEURO XR LTD, Cambridgeshire (GB)

(72) Inventor: Matthew CRITCHLEY, Cambridgeshire (GB)

(73) Assignees: HX LAB LTD, Cambridgeshire (GB); NEURO XR LTD, Cambridgeshire (GB)

(21) Appl. No.: 19/107,526

(22) PCT Filed: Aug. 30, 2023
(86) PCT No.: PCT/GB2023/052236

§ 371 Date: Feb. 27, 2025

(30) Foreign Application Priority Data
Sep. 1, 2022 (GB) 2212702.1

(51) Int. Cl. G06F 3/01

(52) U.S. Cl. CPC G06F 3/015; G06F 2203/011

(57) ABSTRACT

According to an aspect of the disclosure there is provided a system for encoding an emotional reaction of a user to an input virtual environment sensorially experienced by the user, comprising: an emotional data determining unit configured to determine emotional response data relating to an emotional response of the user to the input virtual environment; an anchor determining unit configured to determine at least one anchor within the input virtual environment to which the emotional data is attributable; an emotion encoding unit configured to generate an emotionally encoded representation of the input virtual environment, whereby the emotionally encoded representation of the virtual environment is encoded with data relating to the emotional response of the user to the input virtual environment, based on the input virtual environment, the emotional response data and the at least one anchor.

### TECHNICAL FIELD

The present disclosure relates to a system and method for encoding an emotional reaction of a user to an input virtual environment sensorially experienced by the user.

### BACKGROUND ART

Increasingly, people are experiencing and interacting with virtual environments. Users can experience these virtual environments in different ways including using a virtual reality headset that displays an image of the virtual environment. Users can interact with these virtual environments in different ways including with their own body detected using sensors, or by using hardware controllers. Virtual environments are used particularly in gaming, but are becoming more prevalent in other contexts that replicate “everyday” real environments, such as shops.

In designing a virtual environment with particular attributes, e.g. that elicit a desired user response, there is a distinct lack of tools available that can provide insights into the emotional reaction of a user to the virtual environment.

The present disclosure aims to at least partially solve the above problem.

### SUMMARY OF THE INVENTION

According to an aspect of the disclosure there is provided a system for encoding an emotional reaction of a user to an input virtual environment sensorially experienced by the user, comprising: an emotional data determining unit configured to determine emotional response data relating to an emotional response of the user to the input virtual environment; an anchor determining unit configured to determine at least one anchor within the input virtual environment to which the emotional data is attributable; an emotion encoding unit configured to generate an emotionally encoded representation of the input virtual environment, whereby the emotionally encoded representation of the virtual environment is encoded with data relating to the emotional response of the user to the input virtual environment, based on the input virtual environment, the emotional response data and the at least one anchor.

Optionally, the emotionally encoded representation of the input virtual environment is visually encoded with data relating to the emotional response of the user to the input virtual environment. Optionally, the encoded data is configured to be visually decodable by a second user. Optionally, the encoded data represents the emotional response of the user to the input virtual environment using variation in colour. Optionally, the encoded data represents the emotional response of the user to the input virtual environment using a heat map.

Optionally, the emotionally encoded representation of the input virtual environment comprises an emotionally encoded virtual environment that can be sensorially experienced by the user. Optionally, a user interface unit is configured to enable the user to sensorially experience the emotionally encoded virtual environment.

Optionally, the emotionally encoded representation of the input virtual environment comprises an image of an emotionally encoded virtual environment.

Optionally, the system further comprises: a physiological data collection unit configured to collect physiological response data relating to a physiological response of the user to the input virtual environment; and wherein the emotional data determining unit is configured to determine the emotional response data based on the physiological response data. Optionally, the physiological data relates to at least brain activity. Optionally, the physiological data collection unit comprises at least one EEG sensor configured to sense brain activity. Optionally, the physiological data relates to at least one of eye movement, pupil dilation, heart rate, and sweating.

Optionally, the emotional response data relates to at least one of a level of stress, a level of attentiveness, and a level of relaxation experienced by the user.

Optionally, the virtual environment comprises elements that are sensorially experienced at least one of visually, audibly, haptically, thermally, equilibrioceptively, nociceptively, olfactorially, and gustatorially.

Optionally, the anchor determining unit is configured to determine each anchor based on an interaction between the user and the input virtual environment. Optionally, the interaction comprises at least one of an experienced location of the user within the input virtual environment, an experienced orientation of the user within the input virtual environment, a region of the user's sensory attention within the virtual environment, and an experienced event within the virtual environment.

Optionally, the system further comprises a user interface unit configured to enable a user to sensorially experience the input virtual environment.

Optionally, the system further comprises a virtual environment generating unit configured to generate the input virtual environment.

According to an aspect of the disclosure there is provided a method of encoding an emotional reaction of a user to an input virtual environment sensorially experienced by the user, comprising: determining emotional response data relating to an emotional response of the user to the input virtual environment; determining at least one anchor within the input virtual environment to which the emotional data is attributable; generating an emotionally encoded representation of the input virtual environment, whereby the emotionally encoded representation of the virtual environment is encoded with data relating to the emotional response of the user to the input virtual environment, based on the input virtual environment, the emotional response data and the at least one anchor.

### BRIEF DESCRIPTION OF THE DRAWINGS

Further features of the disclosure will be described below, by way of non-limiting examples and with reference to the accompanying drawings, in which:

FIG. 1 shows a first example system;

FIG. 2 shows example emotionally encoded representations of the input virtual environment;

FIG. 3 shows further example emotionally encoded representations of the input virtual environment;

FIG. 4 shows synchronisation of physiological and virtual environment data; and

FIG. 5 shows the flow of data through an example system.

### DETAILED DESCRIPTION

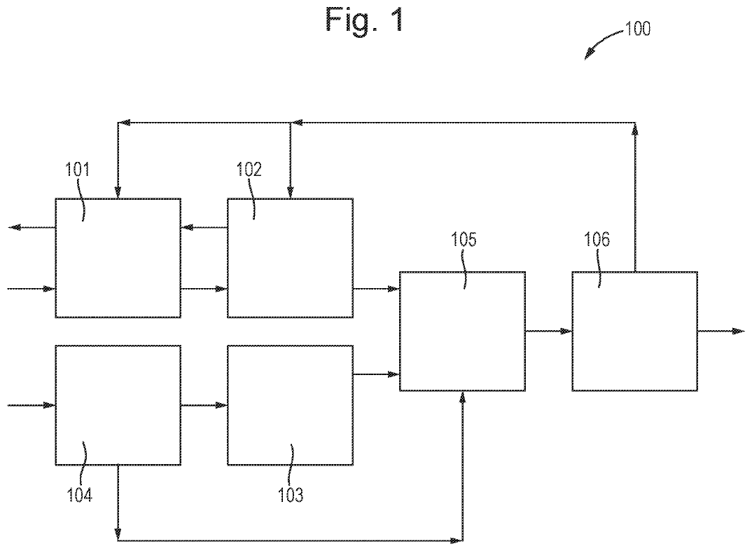

FIG. 1 shows a first example system 100 of the disclosure. As shown, the example system 100 may comprise a user interface unit 101 configured to enable a user to sensorially experience an input virtual environment. The virtual environment may comprise elements that are sensorially experienced at least one of visually, audibly, haptically, thermally, equilibrioceptively, nociceptively, olfactorially, and gustatorially, for example. The user interface unit 101 may comprise sub-units configured to enable the respective sensorial experiences.

As shown in FIG. 1, the input virtual environment may be generated by a virtual environment generating unit 102. The virtual environment generating unit 102 may in data communication with the user interface unit 101. The virtual environment generating unit 102 may provide data and/or instructions to the user interface unit 101 for enabling a user to sensorially experience an input virtual environment.

In an example system, the virtual environment may comprise visual and audible elements that a user experiences though a combination of a visual display and a speaker. The visual display and/or the speaker may form part of a headset worn by a user, e.g. a VR headset such as those from Oculus VR™.

As shown in FIG. 1, the example system 100 comprises an emotional data determining unit 103 configured to determine emotional response data relating to an emotional response of the user to the input virtual environment. The emotional response data may relate to at least one of a level of stress, a level of attentiveness, and a level of relaxation, experienced by the user.

The emotional data determining unit 103 may determine emotional response data relating to an emotional response of the user to the input virtual environment in any number of ways. For example, the emotional data determining unit 103 may be configured to determine the emotional response data based on physiological response data relating to a physiological response of the user to the input virtual environment. As shown in FIG. 1, the example system 100 may comprise a physiological data collection unit 104 configured to collect physiological response data relating to a physiological response of the user to the input virtual environment.

The physiological data may relate to at least one of brain activity, eye movement, pupil dilation, heart rate, and sweating. The physiological data collection unit 104 may comprise corresponding sub-units to collect the respective data.

For example, the physiological data collection unit 104 may comprises EEG sensors configured to sense brain activity. The physiological data collection unit 104 may comprise a camera (e.g. visible or infrared light), and associated software, to track eye movement and/or pupil dilation. The physiological data collection unit 104 may comprise a heart rate monitor (e.g. a Holter monitor). The physiological data collection unit 104 may comprise galvanic skin response electrodes to collect data relating to sweating.

The physiological response data may undergo pre-processing such as correction, filtering and noise removal, e.g. either through a processor forming part of the physiological data collection unit 104 or through another processor within the overall system 100.

An EEG sensor system may comprise of the following, for example:
1. Electrical activity measuring electrodes configured to be placed on or in the proximity to the head with the purpose of receiving and transmitting electrical activity travelling through the scalp having originated form the brain.
2. An amplifier for amplifying and/or converting analogue electrical signals from the sensor into a digital signal that can be processed by a processor.
3. A signal transmitter that will send the data from the amplifier to the processor.

An eye tracking system may comprise of the following, for example:
1. A visual or infrared light camera directed towards the eyes with the purpose of measuring the eye movement and pupil dilation changes of the system user.
2. A receiver unit for the input of visual data which can be translated into digital data.
3. A transmission unit for the purpose of transmission of digital data to a processor.

A decrease in Alpha pattern brainwaves may indicate that the virtual environment has elicited a higher than normal level of attention from the user, for example. Increase in pupil dilation may indicate that the user is attracted towards an object within the virtual environment. Galvanic skin response and heart rate may indicate emotional arousal strength.

As shown in FIG. 1, the example system comprises an anchor determining unit 105 configured to determine at least one anchor within the input virtual environment to which the emotional data is attributable. The anchor determining unit 105 may be configured to determine each anchor based on an interaction between the user and the input virtual environment. The interaction may comprise at least one of an experienced location of the user within the input virtual environment, an experienced orientation of the user within the input virtual environment, a region of the user's sensory attention within the virtual environment, and an experienced event within the virtual environment.

An experienced location may be a location in the virtual environment, at which the user experiences the virtual environment. This may be represented by coordinates within a coordinate system of the virtual environment, for example. An experienced orientation may be the orientation in the virtual environment at which the user experiences the virtual environment. This may be represented by a direction within the coordinate system of the virtual environment, for example.

A region of the users sensory attention may be a region of the virtual environment that receives sensory attention from the user. This may be visual sensory attention, for example based on the experienced location and/or orientation of the user and/or eye tracking data to determine a region of the virtual environment that the user is looking at. However, sensory attention is not limited to visual attention. For example, if the user interacts with the virtual environment haptically, a region of the virtual environment, such as a virtual object, that they experience touching may be a region of haptic sensory attention.

An experienced event may be an event within the virtual environment that is experienced by the user. An experienced event may be any substantial change in the virtual environment experienced by the user. The experienced event may relate to any of the senses that the user is able to experience the virtual environment through, for example a visual event or an audio event. For example, the event may be a planned narrative event within the virtual environment, e.g. part of an unfolding story line.

Anchors may be determined based on virtual environment data, optionally together with physiological data. Virtual environment data may provide data relating to the experienced location and/or an experienced event. Virtual environment data in connection with physiological data may provide data relating to experienced orientation and a region of sensory attention.

The virtual environment data my include interaction data relating to user interaction with the virtual environment, for example if the user is able to interact via a control means, data relating to the manner of control exercised by the user may be used to determine an anchor. Control means may include one or more of movement sensors (e.g. cameras and associated movement recognition software), mechanical controllers (e.g. buttons, joysticks, haptic gloves), means for voice control (e.g. microphone and associated voice recognition software).

Virtual environment data may also include data relating to the virtual environment itself, for example, events within the virtual environment or objects within the virtual environment. Such virtual environment data may be provided by a processing unit configured to generate the virtual environment that is provided to the user interface unit 101 to be experienced by the user.

The specific data used to determine the anchors may depend on the level of user interaction permitted with virtual environment. A low interaction environment will necessitate less physiological data than a high interaction environment, for example.

The data for determining the anchors may be processed by a processing unit of the system to determine the anchors. This processing may be performed by a different processing unit to that which generates the virtual environment. However, in some examples, these processing units may be the same processing units, or different units within the same processing device.

The insights and inferences available from the virtual environment data and the physiological data may differ depending on the data utilised. For example, virtual environment data and/or physiological data relating to the user's movement through the virtual environment may be used to determine which regions of the virtual environment have elicited an emotional response. The virtual environment data and/or physiological data relating to specific objects within the virtual environment, such as the user's experienced proximity to an object or sensory interaction with an object may be used to determine which objects have elicited an emotional response.

The anchors may be parts of the virtual environment with which emotional response data may be attributed. For example, the anchors may be one or more voxels within a three-dimensional virtual environment. These voxels may be associated with a specific location within the virtual environment and/or may be associate with a specific object within the virtual environment, for example. In the first case, the anchor may be a fixed position within the virtual environment. In the latter case, the anchor may not be in a fixed position within in the virtual environment. Anchors may also be associated with a specific time-frame within the user's experience of the virtual environment.

Data for determining anchors may be sampled at the same rate as data for determining emotional reactions. However, they may alternatively be sampled at different rates. If sampled at different rates, data sampled at the higher rate may be averaged over the interval of the lower sampling rate to provide correspondence. The sampling may be performed continuously for the period the user experiences the virtual environment.

As shown in FIG. 1, the system of the disclosure further comprises an emotion encoding unit 106 configured to generate an emotionally encoded representation of the input virtual environment, whereby the emotionally encoded representation of the virtual environment is encoded with data relating to the emotional response of the user to the input virtual environment, based on the input virtual environment, the emotional response data and the at least one anchor.

The emotionally encoded representation of the input virtual environment may be visually encoded with data relating to the emotional response of the user to the input virtual environment. The encoded data may be configured to be visually decodable by a second user. The second user may be different from the first user, or the same user. The encoded data may represent the emotional response of the user to the input virtual environment using variation in colour. For example, the encoded data may represent the emotional response of the user to the input virtual environment using a heat map.

In some examples, the emotionally encoded representation of the input virtual environment comprises an emotionally encoded virtual environment that can be sensorially experienced by the user. For example, the emotionally encoded representation of the input virtual environment may be a modified version of the input virtual environment. In this case, the user interface unit 101 may be configured to enable the user to sensorially experience the emotionally encoded virtual environment.

In some examples, the emotionally encoded representation of the input virtual environment may comprise an image of an emotionally encoded virtual environment. For example, the emotionally encoded representation of the input virtual environment may comprise a two-dimensional image of a three-dimensional input virtual environment. This image may be a top-down (plan) view of the virtual environment, for example.

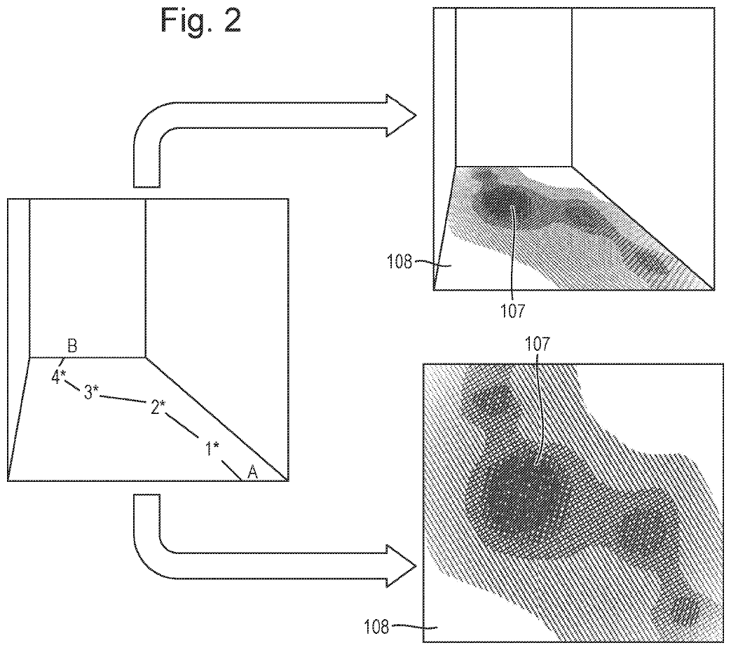

FIG. 2 shows different emotionally encoded representations of an input virtual environment when a user moved through a path in the virtual environment from A to B, as shown in the in the left hand part of the Figure. The numbers 1 to 4 in the Figure denote points along the path. In this example, the anchors are based on the user's location in the virtual environment. The left hand parts of the Figure show a heat map 107 of the user's emotional reaction at different locations in the virtual environment 108. The top right part of the Figure is an example of a three-dimensional emotionally encoded representation, whereas the bottom right part of the Figure is an example of a two-dimensional emotionally encoded representation.

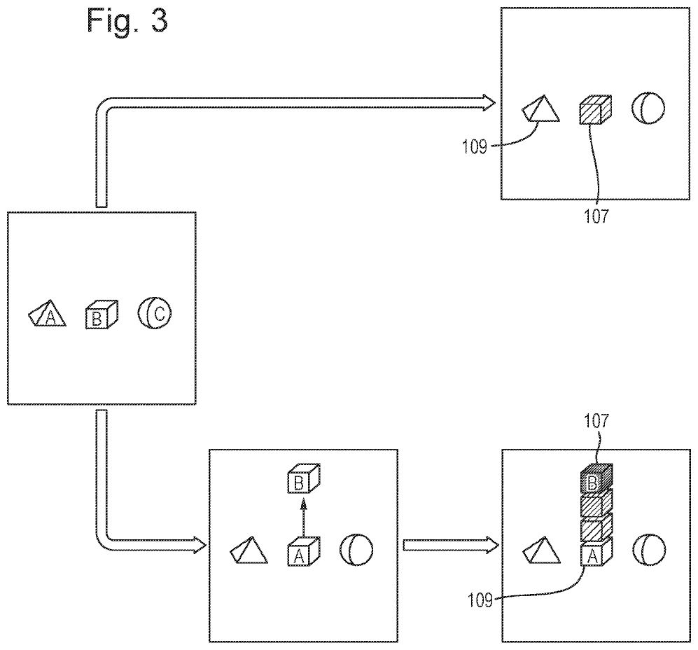

FIG. 3 shows different emotionally encoded representations of an input virtual environment when a user interacts with an object in the virtual, as shown in the in the left hand part of the Figure. In this example, the anchors are based on the object interacted with in the virtual environment. As shown in the top right part of the Figure, in some examples, e.g. when a user is in proximity to a virtual object, the object itself may be emotionally encoded, e.g. with a colour corresponding with the user's emotional reaction. As shown in the bottom right part of the Figure, in some examples, e.g. where a user moves a virtual object, a visual representation of the interaction may be provided together with emotional encoding of the object.

In some examples, the emotionally encoded representation of the input virtual environment may be fed back to the user or a second user as it is generated. Alternatively or additionally, the emotionally encoded representation may be stored in a memory for viewing later.

The emotionally encoded representation of the input virtual environment may be comprise a representation of the input virtual environment integrated with the encoded emotional reaction data. In this case, the data relating to the encoding may be indistinguishable from of the data relating to the representation of the input virtual environment. Alternatively, or additionally, the emotionally encoded representation of the input virtual environment may comprise a representation of the input virtual environment overlaid (or augmented) with the encoded emotional reaction data. In this case, the data relating to the encoding may be separate from the data relating to the representation of the input virtual environment. For example, the data relating to the encoding may be a three dimensional heatmap.

Generating an emotionally encoded representation of the input virtual environment may be preceded by combining emotional reaction data and/or or physiological data with the anchors. This may comprise mapping emotional reaction data and/or physiological data to anchors, or vice versa. For example, emotional reaction data may be determined based on physiological data before the emotional data is combined with the anchors. In another example, physiological data may be combined with the anchors before emotional reaction data is determined based on physiological data.

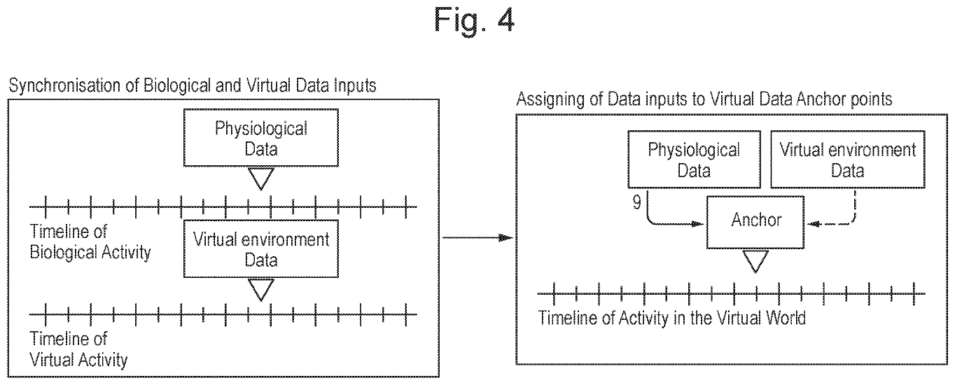

In an example system, emotional reaction data for a specific time may be mapped to an anchor for the same time, i.e. relating to the user's interaction with the virtual environment at the specific time. The emotional reaction data may then be determined and encoded as a heat map within an encoded virtual environment based on the anchors. This is shown in FIG. 4, whereby physiological data is collected to determine emotional reaction data and virtual environment data is collected to determine an anchor in the left hand part of the Figure and these are combined in the right hand part of the Figure.

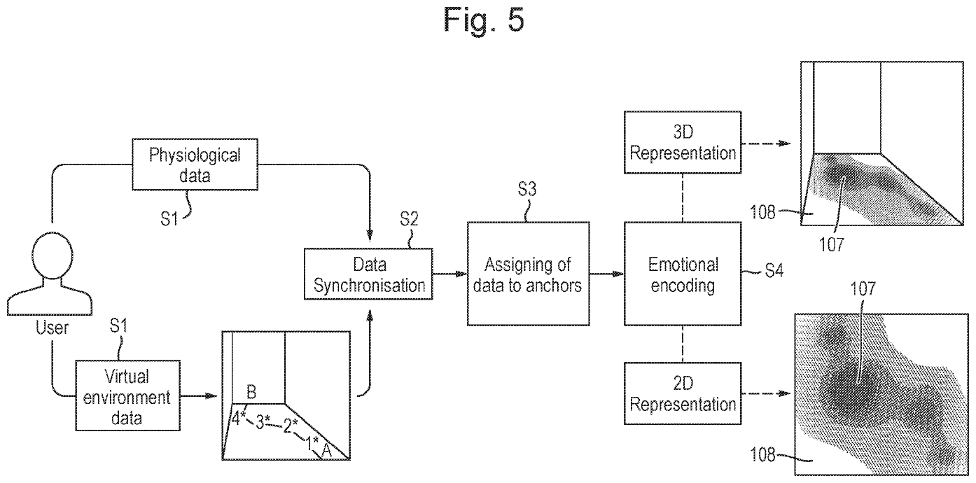

FIG. 5 shows the flow of data through an example system. As shown, physiological data and virtual environment data are collected at step S1, synchronised at step S2 and physiological data assigned to an anchor at step S3. An emotionally encoded representation of the input virtual environment is then generated in step S4. Three-dimensional and two-dimensional representations are shown in FIG. 4 as examples.

The emotional reaction data may indicate a level of one or more emotional states including but not limited to stress, attention, and relaxation. Colours, changes in colours, changes in colour tones and strengths of colours or changes in opaqueness may be used to visually represent these emotional states, e.g. in a heat map. The emotional states displayed may be configurable by a user of the system.

In an example, the system may collect all different types of physiological data and virtual environment data regardless of the intended motional states to be encoded. The system may be configured to switch between the emotional states encoded.

A colour range or colour strength may be assigned to correspond with each emotional state. The specific colour may be configurable by the user. These colours may represent the strength, decrease, increase or other change; for example, a light blue may represent a lower attention measurement, whilst a dark blue may represent a measurement of high attention. If the user moved from the co-ordinate of 0,0,0 to 0,10,10 and their attention levels were measured to have increased from low attention to high attention at an even rate between the two points, the areas around which they began movement, the area in which they moved, and the destination area, may be coloured, starting with a light blue and demonstrating a gradual change to a dark blue across this path.

In the case of a two-dimensional visual representation, such as a top-down view or a user-centric view of the virtual environment, a colour overlay may be placed over the image of the environment. This overlay is generated by analysing the data for its inference of each metric strength, and then applying the appropriate colour range to the correct spatial co-ordinates within the visual representation of the environment.

In the case of the utilisation of the original virtual environment in the generation of the visual heatmap, such as overlaying the coloured heatmap onto the original virtual environment itself, copies of the original files containing the representations of the 3D objects in the environment may be created and altered. These files may be located in or linked to the software generating the 3D environment. These files will follow the same 3D layout as the original file, however altering the colours in the appropriate manner to display the aforementioned metrics.

In the case the coloured overlay demonstrating which activities, or objects induce certain metrics, the files relating to or linked to these specific 3D objects may be copied, and altered colours will be applied in the same manner.

1. A system for encoding an emotional reaction of a user to an input virtual environment sensorially experienced by the user, comprising:
an emotional data determining unit configured to determine emotional response data relating to an emotional response of the user to the input virtual environment;
an anchor determining unit configured to determine at least one anchor within the input virtual environment to which the emotional data is attributable;
an emotion encoding unit configured to generate an emotionally encoded representation of the input virtual environment, whereby the emotionally encoded representation of the virtual environment is encoded with data relating to the emotional response of the user to the input virtual environment, based on the input virtual environment, the emotional response data and the at least one anchor.

2. The system of claim 1, wherein the emotionally encoded representation of the input virtual environment is visually encoded with data relating to the emotional response of the user to the input virtual environment.

3. The system of claim 2, wherein the encoded data is configured to be visually decodable by a second user.

4. The system of claim 3, wherein the encoded data represents the emotional response of the user to the input virtual environment using variation in colour.

5. The system of claim 3 or 4, wherein the encoded data represents the emotional response of the user to the input virtual environment using a heat map.

6. The system of any preceding claim, wherein the emotionally encoded representation of the input virtual environment comprises an emotionally encoded virtual environment that can be sensorially experienced by the user.

7. The system of claim 6, wherein a user interface unit is configured to enable the user to sensorially experience the emotionally encoded virtual environment.

8. The system of any preceding claim, wherein the emotionally encoded representation of the input virtual environment comprises an image of an emotionally encoded virtual environment.

9. The system any preceding claim, wherein the system further comprises:
a physiological data collection unit configured to collect physiological response data relating to a physiological response of the user to the input virtual environment; and
wherein the emotional data determining unit is configured to determine the emotional response data based on the physiological response data.

10. The system of claim 9, wherein the physiological data relates to at least brain activity.

11. The system of claim 10, wherein the physiological data collection unit comprises at least one EEG sensor configured to sense brain activity.

12. The system of any one of claims 9 to 11, wherein the physiological data relates to at least one of eye movement, pupil dilation, heart rate, and sweating.

13. The system of any preceding claim, wherein the emotional response data relates to at least one of a level of stress, a level of attentiveness, and a level of relaxation experienced by the user.

14. The system of any preceding claim, wherein the virtual environment comprises elements that are sensorially experienced at least one of visually, audibly, haptically, thermally, equilibrioceptively, nociceptively, olfactorially, and gustatorially.

15. The system of any preceding claim, wherein the anchor determining unit is configured to determine each anchor based on an interaction between the user and the input virtual environment.

16. The system of claim 7, wherein the interaction comprises at least one of an experienced location of the user within the input virtual environment, an experienced orientation of the user within the input virtual environment, a region of the user's sensory attention within the virtual environment, and an experienced event within the virtual environment.

17. The system of any preceding claim, further comprising a user interface unit configured to enable a user to sensorially experience the input virtual environment.

18. The system of any preceding claim, further comprising a virtual environment generating unit configured to generate the input virtual environment.

19. A method of encoding an emotional reaction of a user to an input virtual environment sensorially experienced by the user, comprising:
determining emotional response data relating to an emotional response of the user to the input virtual environment;
determining at least one anchor within the input virtual environment to which the emotional data is attributable;
generating an emotionally encoded representation of the input virtual environment, whereby the emotionally encoded representation of the virtual environment is encoded with data relating to the emotional response of the user to the input virtual environment, based on the input virtual environment, the emotional response data and the at least one anchor.
